(19) United States
(12) Patent Application Publication
(10) Pub. No.: US 2008/0189957 A1
(43) Pub. Date: Aug. 14, 2008

(54) Bi-metal chisel blade

(75) Inventor: Scott Kasper, Killingworth, CT (US)

Correspondence Address: PILLSBURY WINTHROP SHAW PITTMAN, LLP, P.O. BOX 10500, MCLEAN, VA, 22102, US

(73) Assignee: THE STANLEY WORKS, New Britain, CT (US)

(21) Appl. No.: 11/705,103

(22) Filed: Feb. 12, 2007

(51) Int. Cl. B25D 3/00; B23P 11/00

(52) U.S. Cl. 30/167; 29/428

(57) ABSTRACT

A chisel with a bi-material blade comprising a main body of low grade steel and a cutting portion of higher grade steel. The cutting portion of higher grade steel provides longer life and decreases the need for frequent sharpening. The main body and cutting portion are connected using an arcuate interface. Additionally, the main body and cutting portion may have a radiussed cross-sectional connection. The arcuate interface and radiussed cross-section help absorb the shear and impact forces applied to the tool.

### BACKGROUND OF THE INVENTION

1. Field of Invention

The present invention is generally related to chisels. More particularly, the application relates to chisels having an improved cutting insert.

2. Description of Related Art

Chisels typically include a blade with a sharp cutting edge for carving, shaving, or cutting work pieces. The sharpened edge of the blade becomes dull with continuous use, requiring the craftsman to re-sharpen and re-hone the blade edge regularly in order to produce a satisfactory and predictable performance.

Prior art has attempted to alleviate the craftsman's need to sharpen the blade by providing a replaceable chisel blade. These blades are removable from the tool shank and allow the craftsman to replace the blade when needed.

Other chisels attempt to lengthen the life of the blade by constructing a blade of relatively harder metallic material. Specifically, it is known to provide a chisel blade made of two different steel materials, a lower grade, less costly base steel portion, and a higher grade, harder, and more costly steel portion for forming the cutting edge.

However, in such bi-material blade structures, the connection of the blade edge portion to the base metal portion is subject to stress and strain.

There is a need in the art to improve upon the known chisels of the prior art.

### SUMMARY OF THE INVENTION

One embodiment comprises a chisel comprising a handle, an elongated working portion, and a shank portion. The elongated working portion and a shank portion are joined with the handle. The elongate working portion has a main body portion and cutting portion. The main body portion is formed from a relatively lower grade steel, and the cutting portion is formed from a relatively higher grade steel in comparison with the lower grade steel of the main body portion. The cutting portion has a sharpened cutting edge at one end thereof and an arcuate force receiving surface disposed in spaced relation from the cutting edge. The main body portion has a driving engagement surface with an arcuate shape that mates with the arcuate configuration of the force receiving surface of the cutting portion.

In an embodiment, the arcuate configuration of the force receiving surface and the arcuate shape of the driving engagement surface may form a portion of an arc. Alternatively, the arcuate configuration of the force receiving surface and the arcuate shape of the driving engagement surface may form one of a sinusoidal, parabolic, or elliptical configuration.

The main body portion may have a reduced thickness region defining a recess for receiving the cutting portion. The main body portion may have a larger thickness region adjacent to the reduced thickness region, and the combined thickness of the reduced thickness region and the cutting portion may be configured to provide a generally flush transition with the larger thickness region.

The driving engagement surface may define a transitioning surface between the larger thickness region and the reduced thickness region. Further, the driving engagement surface may generally slope rearwardly as it extends from the larger thickness region towards the reduced thickness region. A juncture between the driving engagement surface and the reduced thickness region may define a radiussed cross-sectional configuration.

In another embodiment, a chisel comprises a handle, an elongated working portion, and a shank portion. The elongated working portion and shank portion are joined with the handle. The working portion has a main body portion and cutting portion. The main body portion is formed from a relatively lower grade steel, and the cutting portion is formed from a relatively higher grade steel in comparison with the lower grade steel of the main body portion. The cutting portion has a sharpened cutting edge at one end thereof and a force receiving surface disposed in spaced relation from the cutting edge. The main body portion has a recess with a driving engagement surface for receiving the force receiving surface of the cutting portion. The driving engagement surface of the main body portion has a radiussed cross-sectional configuration that generally slopes rearwardly when it mates with the force receiving surface of the cutting portion.

The recess may be defined by a reduced thickness region. The main body portion may have a larger thickness region adjacent to the reduced thickness region, and the combined thickness of the reduced thickness region and the cutting portion may be configured to provide a generally flush transition with the larger thickness region. The driving engagement surface has an arcuate shape that mates with the arcuate configuration of the force receiving surface of the cutting portion.

In an embodiment, the arcuate shape of the driving engagement surface and the arcuate configuration of the force receiving surface form a portion of an arc. Alternatively, the arcuate shape of the driving engagement surface and the arcuate configuration of the force receiving surface form one of a sinusoidal, parabolic, or elliptical configuration.

Another embodiment provides a method of assembling a chisel, comprising: forming a main body portion of a lower grade steel with a driving engagement surface of arcuate shape; forming a cutting portion of a higher grade steel in comparison with the lower grade steel of the main body portion with an arcuate force receiving surface disposed in a spaced relation to a cutting edge; mating the driving engagement surface of the main body portion and force receiving surface of the cutting portion to form a chisel blade; and connecting the chisel blade with a handle.

The method may further comprise forming a transitioning surface on the driving engagement surface that generally slopes rearwardly. The method may also comprise forming the driving engagement surface and the force receiving surface with a radiussed cross-sectional configuration.

In an embodiment, the higher grade steel of the cutting portion has a hardness range of 57 to 62 HRC and the lower grade steel of the main body portion has a hardness range of 35 to 45 HRC.

Other objects, features, and advantages of the present invention will become apparent from the following detailed description, the accompanying drawings, and the appended claims.

### BRIEF DESCRIPTION OF THE DRAWINGS

FIG. 1 shows an exploded perspective view of one embodiment of a chisel in accordance with the present invention;

FIG. 2 shows a perspective view of the chisel of FIG. 1 with the main body portion and cutting portion connected;

FIG. 3 shows a top view of the of the chisel blade;

FIG. 4 shows a bottom view of the chisel blade, illustrating an arcuate connection between the main body and cutting portion;

FIG. 5 shows a side view of the chisel blade, illustrating a radiussed cross-sectional juncture; and

FIG. 6 shows a detail view of the mating of the main body portion and the cutting portion of FIG. 5, particularly a radiussed juncture with a rearward slope.

### DETAILED DESCRIPTION OF THE INVENTION

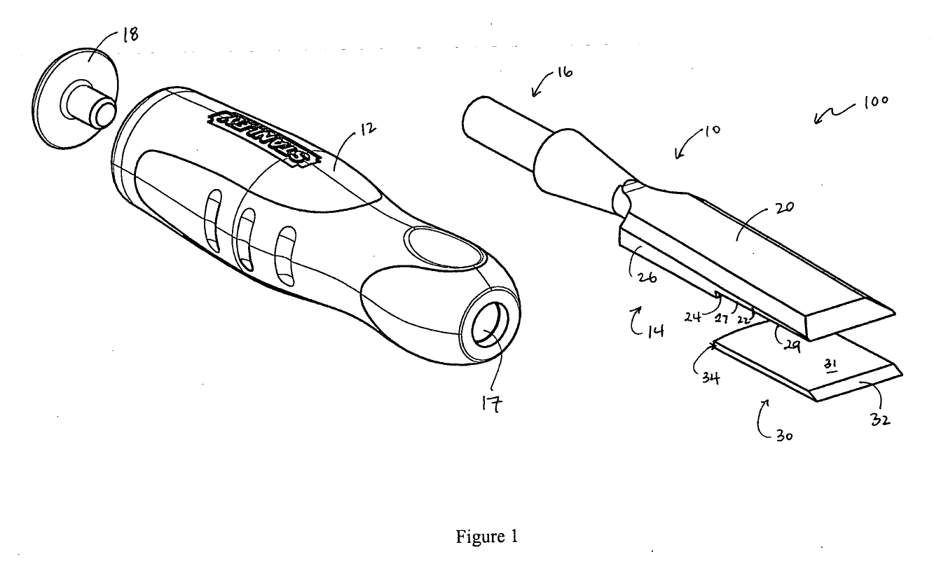

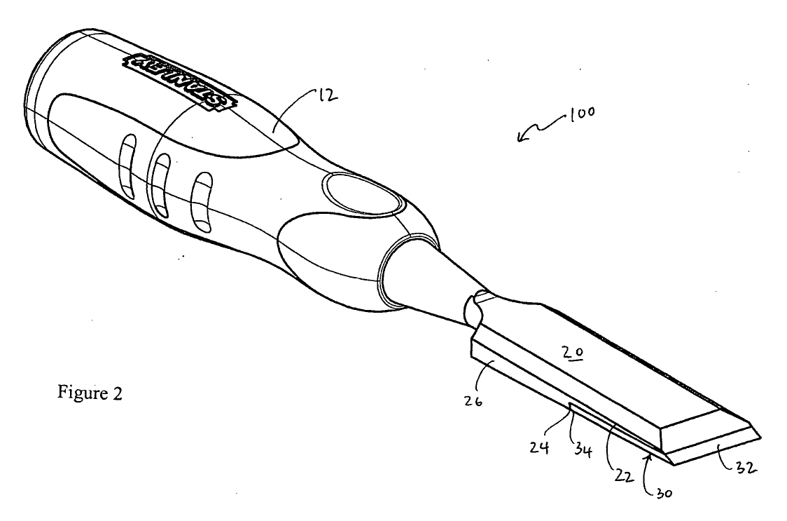

Referring now more particularly to the drawings, FIG. 1 is an exploded perspective view and FIG. 2 is an assembled perspective view of a chisel 100 in accordance with one embodiment of the invention. The chisel 100 includes a blade 10 and a handle 12 that are connected to one another. Handle 12 comprises an opening 17 for receiving shank portion 16 of chisel blade 10. In an alternate embodiment, handle 12 may be molded around shank portion 16. Handle 12 may also comprise an end cap 18 for striking by another tool, such as a hammer. Handle 12 and end cap 18 are made of materials known to withstand impact. For example, handle 12 may be made of a polymer, and end cap 18 may be made of steel. Handle 12 may be contoured, shock absorbent, ergonomic, or other type of handle known in the art.

Chisel blade 10 comprises an elongate working portion 14 that is joined with a shank portion 16. The joining of the shank portion 16 and handle 12 form a hand-held chisel 100 that may be used to carve, shave, or cut work pieces made of wood, for example. The elongate working portion 14 of chisel blade 10 is formed from main body portion 20 and cutting portion 30.

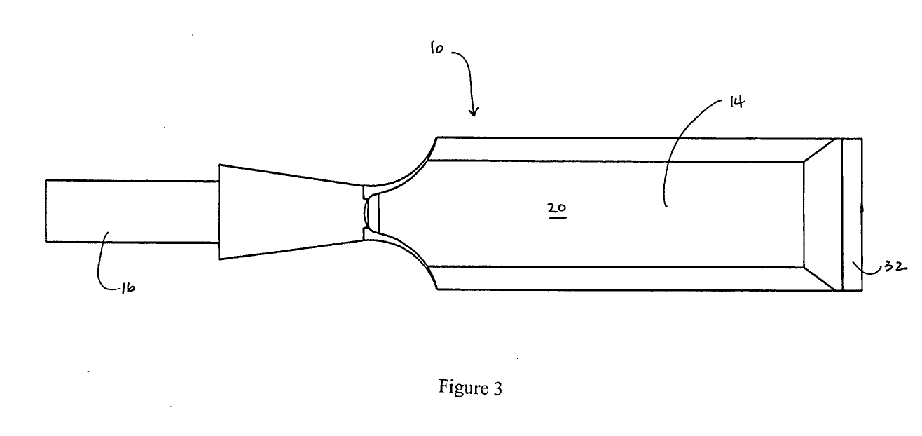

As seen in FIG. 2 and the top plan view of FIG. 3, the cutting portion 30 has a cutting edge 32 that extends beyond the body portion 20 and defines the leading surface of the blade 10.

In one embodiment, body portion 20 is made of a lower grade carbon steel in comparison with cutting portion 30, thus forming a bimetallic blade. An exemplary embodiment would include a main body portion 20 made of carbon steel having a Rockwell Hardness (HRC) in the range of 35 to 45 HRC, and a cutting portion 30 made of carbon steel having a Rockwell Hardness (HRC) in the range of 57 to 62 HRC. The use of the lower grade steel for main body portion 20 provides a cost effective base material, while the more expensive cutting portion 30 provides longer edge life and a reduced need for sharpening.

Main body portion 20 defines reduced thickness region 22 toward a forward portion thereof, while the rearward longitudinal portion defines a larger thickness region 26. Larger thickness region 26 is adjacent to the reduced thickness region 22. As best seen in FIGS. 1, 5, and 6, the forward longitudinal portion of reduced thickness region 22 defines a recess 27 in main body portion 20 for receiving cutting portion 30. The recess 27 has a major surface 29 for engaging a back surface 31 of cutting portion 30. Also as shown in the Figures, the main body portion 20 includes a surface 24 defining a transition surface between larger thickness region 26 and reduced thickness region 22.

The surface 24 engages a rearward surface 34 of the cutting portion 30. When the end of handle 12 receives an impact (e.g., from a hammer), force is transmitted through the main body surface 24 to the rearward cutting portion surface 34. Thus, the surface 24 can be considered to be a driving engagement surface while the surface 34 can be considered to be a force receiving surface.

Cutting portion 30 is an insert that may be attached to main body portion 20 by metal bonding adhesive, electric resistance welding or brazing, induction welding or brazing, or electron beam welding for adjoining or engaging surfaces, for example. The force receiving surface 34 is disposed in a spaced relation from cutting edge 32, but is not necessarily at the rearwardmost end of the cutting portion 30. For example, in one embodiment (not shown), a discrete rearwardmost portion of the cutting portion 30 may project rearwardly of the main force receiving surface 34, and not engage the driving surface 24, although such a configuration is not preferred.

The thickness of cutting portion 30 in one embodiment is configured in relation to main body portion 20 to provide a smooth, transitional fit. That is, when cutting portion 30 is inserted into recess 27 and attached to main body portion 20, the combined thickness of reduced thickness region 22 of main body 20 and the thickness of cutting portion 30 (at least the rearward portions thereof) are configured to provide a generally flush transition with larger thickness region 26.

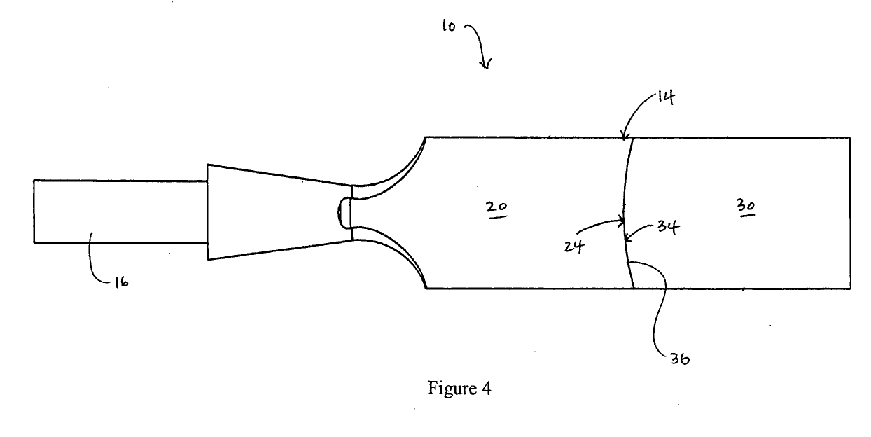

As shown in FIG. 4, the driving engagement surface 24 and the force receiving surface 34 meet at an arcuate interface 36. Specifically, the two mating surfaces 24 and 34 have a corresponding mating arcuate shape or configuration when extending laterally from one side of the blade to the other side of the blade, as seen in the bottom plan view of FIG. 4. The arcuate surface interface of the cutting portion and main body portion is designed to spread the shear and impact force over a relatively larger surface area in comparison with a linear interface.

In one embodiment, the arcuate shape of the driving engagement surface and the arcuate configuration of the force receiving surface form a portion of an arc. In another embodiment, the arcuate shape may be of a circular, sinusoidal, parabolic, or elliptical configuration. The use of an arcuate shape for mating is an advantage to the user or craftsman in that the arcuate shape provides a larger surface area which assists in the absorption of shock and shear loads and forces that are created axial to the tool handle during use (such as impact from a hammer).

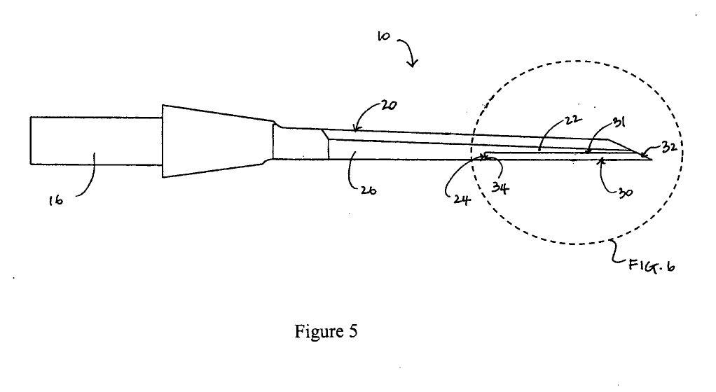

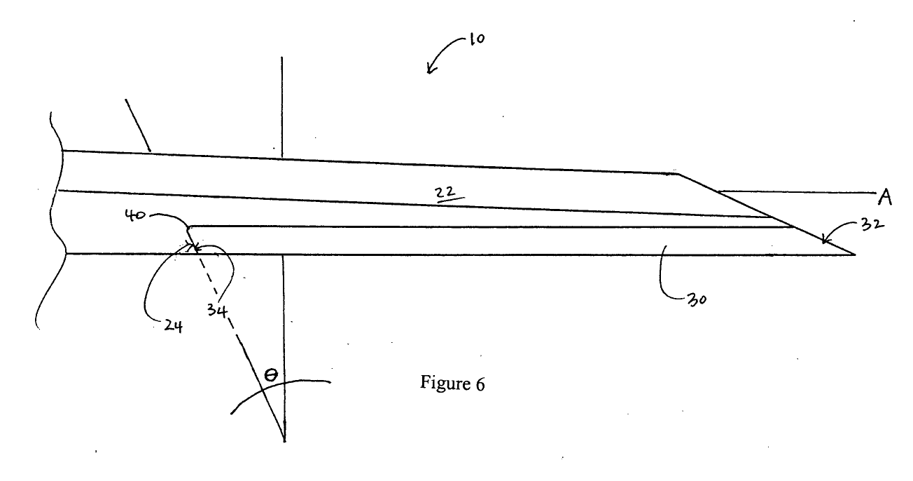

The side view of FIG. 5 illustrates also that the interface between the main body portion 20 and the rearward portion of cutting portion 30 defines a radiussed cross-sectional juncture. FIG. 6 shows a detailed view of the juncture in a longitudinal cross section. As shown, driving engagement surface 24 is shown as generally sloping rearwardly (i.e., towards the handle) as it extends from larger thickness region 26 towards reduced thickness region 22. The rearward slope is, in one embodiment, at an angle θ of between 5° and 60° with respect to a plane that is perpendicular to the longitudinal axis A of the blade. As also seen in FIG. 6, the juncture between driving engagement surface 24 and reduced thickness region 22 defines a radius of curvature at the rounded corner 40 of the engagement. In one embodiment, the radius of curvature has a dimension of 0.010 inches. The engaging radius between the main body portion 20 and cutting portion 30 further helps to absorb the shear and impact load that will be present when the tool is impacted with a load axial to the tool handle.

The combination of the arcuate lateral interface and radiussed longitudinal, and each individually, at the interface between the cutting portion 30 and the body portion 20 function to reduce stress and strain of the interface driving impact in comparison with a linear, square cornered interface.

While the principles of the invention have been made clear in the illustrative embodiments set forth above, it will be apparent to those skilled in the art that various modifications may be made to the structure, arrangement, proportion, elements, materials, and components used in the practice of the invention.

It will thus be seen that the objects of this invention have been fully and effectively accomplished. It will be realized, however, that the foregoing preferred specific embodiments have been shown and described for the purpose of illustrating the functional and structural principles of this invention and are subject to change without departure from such principles. Therefore, this invention includes all modifications encompassed within the spirit and scope of the following claims.

What is claimed is:

1. A chisel, comprising:
a handle;
an elongated working portion and a shank portion joined with the handle, the elongate working portion having a main body portion and cutting portion;
the main body portion being formed from a relatively lower grade steel, and the cutting portion being formed from a relatively higher grade steel in comparison with the lower grade steel of the main body portion;
the cutting portion having a sharpened cutting edge at one end thereof and an arcuate force receiving surface disposed in spaced relation from the cutting edge;
the main body portion having a driving engagement surface, the driving engagement surface having an arcuate shape that mates with the arcuate configuration of the force receiving surface of the cutting portion.

2. The chisel according to claim 1, wherein the arcuate configuration of the force receiving surface and the arcuate shape of the driving engagement surface form a portion of an arc.

3. The chisel according to claim 1, wherein the arcuate configuration of the force receiving surface and the arcuate shape of the driving engagement surface form one of a sinusoidal, parabolic, or elliptical configuration.

4. The chisel according to claim 1, wherein the main body portion has a reduced thickness region defining a recess for receiving the cutting portion.

5. The chisel according to claim 4, wherein the main body portion has a larger thickness region adjacent to the reduced thickness region, and wherein the combined thickness of the reduced thickness region and the cutting portion are configured to provide a generally flush transition with the larger thickness region.

6. The chisel according to claim 5, wherein the driving engagement surface defines a transitioning surface between the larger thickness region and the reduced thickness region.

7. The chisel according to claim 6, wherein the driving engagement surface generally slopes rearwardly as it extends from the larger thickness region towards the reduced thickness region.

8. The chisel according to claim 7, wherein a juncture between the driving engagement surface and the reduced thickness region defines a radiussed cross-sectional configuration.

9. The chisel according to claim 1, wherein the relatively higher grade steel of the cutting portion has a hardness range of 57 to 62 HRC.

10. The chisel according to claim 1, wherein the relatively lower grade steel of the main body portion has a hardness range of 35 to 45 HRC.

11. A chisel, comprising:
a handle;
an elongated working portion and a shank portion joined with the handle, the working portion having a main body portion and cutting portion;
the main body portion being formed from a relatively lower grade steel, the cutting portion being formed from a relatively higher grade steel in comparison with the lower grade steel of the main body portion;
the cutting portion having a sharpened cutting edge at one end thereof and a force receiving surface disposed in spaced relation from the cutting edge;
the main body portion having a recess with a driving engagement surface for receiving the force receiving surface of the cutting portion;
wherein the driving engagement surface of the main body portion has a radiussed cross-sectional configuration that generally slopes rearwardly when mating with the force receiving surface of the cutting portion.

12. A chisel according to claim 11, wherein the recess is defined by a reduced thickness region.

13. A chisel according to claim 12, wherein the main body portion has a larger thickness region adjacent to the reduced thickness region, and wherein the combined thickness of the reduced thickness region and the cutting portion are configured to provide a generally flush transition with the larger thickness region.

14. A chisel according to claim 11, wherein the driving engagement surface has an arcuate shape that mates with the arcuate configuration of the force receiving surface of the cutting portion.

15. A chisel according to claim 14, wherein the arcuate shape of the driving engagement surface and the arcuate configuration of the force receiving surface form a portion of an arc, sinusoid, parabola, or ellipse.

16. A chisel according to claim 11, wherein the higher grade steel of the cutting portion has a hardness range of 57 to 62 HRC and the lower grade steel of the main body portion has a hardness range of 35 to 45 HRC.

17. A method of assembling a chisel, comprising:
forming a main body portion of a lower grade steel with a driving engagement surface of arcuate shape;
forming a cutting portion of a higher grade steel in comparison with the lower grade steel of the main body portion with an arcuate force receiving surface disposed in a spaced relation to a cutting edge;
mating the driving engagement surface of the main body portion and force receiving surface of the cutting portion to form a chisel blade; and
connecting the chisel blade with a handle.

18. A method of assembling a chisel according to claim 17, further comprising forming a transitioning surface on the driving engagement surface that generally slopes rearwardly.

19. The chisel according to claim 18, further comprising forming the driving engagement surface and the force receiving surface with a radiussed cross-sectional configuration.

20. The chisel according to claim 17, wherein the higher grade steel of the cutting portion has a hardness range of 57 to 62 HRC and the lower grade steel of the main body portion has a hardness range of 35 to 45 HRC.
